(19) United States
(12) Patent Application Publication
(10) Pub. No.: US 2025/0376586 A1
(43) Pub. Date: Dec. 11, 2025

(54) Rubber And Resin Composite Weapon Handle Device

(71) Applicant: Matt Kriebs, Belvidere, IL (US)

(72) Inventor: Matt Kriebs, Belvidere, IL (US)

(21) Appl. No.: 19/076,440

(22) Filed: Mar. 11, 2025

Related U.S. Application Data
(60) Provisional application No. 63/658,590, filed on Jun. 11, 2024.

(51) Int. Cl. C08L 63/00; B29C 43/00; B29K 21/00; B29K 63/00

(52) U.S. Cl. CPC C08L 63/00; B29C 43/003; B29K 2021/00; B29K 2063/00; C08L 2203/30

(57) ABSTRACT

A rubber and resin composite weapon handle material for enhancing grip on a weapon particularly in wet conditions includes 5-8% rubber and 92-95% resin formed into a cured block which can be shaped. formed and attached to a weapon as a grip or handle.

### (b) CROSS-REFERENCE TO RELATED APPLICATIONS

This application claims priority to the provisional application 63/658,590 filed on Jun. 11, 2024.

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to weapon grip materials and more particularly pertains to a new weapon grip material for enhancing grip on a weapon particularly in wet conditions.

### (2) Description of Related Art Including Information Disclosed Under 37 CFR 1.97 and 1.98

The prior art relates to weapon grip materials. Known weapon grip materials can enhance grip on a weapon such as a knife or firearm. What is lacking in known prior art is use of crumb rubber with resin to particularly enhance gripping in wet conditions.

### (h) BRIEF SUMMARY OF THE INVENTION

An embodiment of the disclosure meets the needs presented above by generally comprising 5-8% rubber and 92-95% resin formed into a cured block which can be shaped, formed and attached to a weapon as a grip or handle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

### (j) DETAILED DESCRIPTION OF THE INVENTION

The rubber and resin composite weapon handle material generally comprises 5-8% rubber and 92-95% resin by weight. The rubber comprises crumb rubber is 30-90 mesh sized. More specifically, a powered sieve with a top screen may be used, having an aperture of 0.034″ and a bottom screen that is either 50 or 80 mesh size. It is noted more vibrant colors of the rubber crumb as better suited to the 50 mesh size as more dust is filtered out and the vibrant color is better expressed. The weapon grip material is formed as described below into a block which may be further shaped and attached to a weapon in a conventional manner. To form a block the rubber is between 3.5-5.5 ounces of rubber. A weight of the resin may be between 55 and 75 ounces. The resin may more specifically be an epoxy resin enhancing engagement of the resin to the rubber crumb within the produced block. The amounts can be scaled up or down to address different amounts of the material needed to form a block having the size and shape required for producing a handle or grip from the weapon.

Alternatively, sheets may be formed instead of blocks. Sheets are produced in approximately 12″×18″ sheets in various thicknesses. This requires volumes from 1500 mL to 6100 mL following the same ratios as stated previously.

A method of making the weapon grip material includes mixing the crumb rubber with the resin to form a mixture in which the rubber is suspended within and substantially evenly distributed throughout the resin. The mixture is placed in a vacuum to cleave air from the mixture. The mixture is poured into a mold and then placed under pressure in the mold. The pressure is from 60 to 100 pounds per square inch. It is contemplated that curing can be achieved at even higher pressures. The mixture is allowed to cure while under pressure. Heat can be applied to the mixture to alleviate surface bubbling. This can be done prior to curing with a heat gun to pop any bubbles that rise to the surface after the vacuum is applied. Post-curing application of heat may further alleviate stress in the resin enhancing durability and reducing warping. The resulting block of the weapon handle material can then be attached to a weapon shaft, handle or other structure before or after shaping of the block to form a grip for the weapon. The resulting surface of the grip will have exposed rubber crumb and resin producing enhanced friction, particularly when the grip is wet. Additionally, dye may be added as needed to achieve a desired color of the mixture. The dye may be in powdered or liquid form. It is contemplated that the amount of dye added will vary depending on desired color results but generally, the amount of dye required for the desired color would not adversely influence results when making the mixture according to the relative amounts of the rubber and resin as described above.

It is also noted that the mixture may be cast in place within a mold that provides for a handle or shaft of the weapon to be inserted into the mixture within the mold allowing the mixture to cure and become fixed to the handle or shaft. The cured material may further be provided in block or sheet form where it can be shaped, sanded, or otherwise machined for achieving the desired grip or handle for the weapon.

In use, the weapon handle material is formed according to the method above and then used for formation of a grip or handle of a weapon.

It is further contemplated that the rubber crumb and epoxy resin may be incorporated as sheets in between layers of material such as paper, cloth, or other substrate, in the manner of composite material, known under the trade name MICARTA, for further strengthening of the resulting weapon handle block used to form a weapon grip or handle. It is contemplated that the substrate would be soaked in a low viscosity resin with uncured rubber and resin being positioned between layers of the substrate. A sieve may be used for application of rubber crumb between layers for substantially even distribution. High pressure would then be applied after sufficient layers are provided to form a block of material required for a particular grip or handle to ultimately be created.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rubber and resin weapon grip material comprising:
5-8% rubber, and
92-95% resin.

2. The rubber and resin weapon grip material of claim 1 wherein said rubber comprises crumb rubber, said crumb rubber being 30-90 mesh sized.

3. The rubber and resin weapon grip material of claim 2, further comprising said rubber being 3.5-5.5 ounces of rubber.

4. The rubber and resin weapon grip material of claim 1, further comprising a weight of said resin being between 55 and 75 ounces.

5. The rubber and resin weapon grip material of claim 1, wherein said resin is epoxy resin.

6. A method of making a weapon grip material comprising:
mixing crumb rubber with resin to form a mixture;
placing said mixture in a vacuum to cleave air from the mixture;
pouring the mixture into a mold;
placing the mixture in the mold under pressure;
allowing the mixture to cure while under pressure.

7. The method of claim 6, further comprising a step of applying heat to the mixture after placing the mixture in a vacuum to alleviate surface bubbling.

8. The method of claim 6 wherein said pressure is from 60 to 100 pounds per square inch.

9. The method of claim 6, further comprising said crumb rubber being 30-90 mesh sized.

10. The method of claim 6, further comprising said crumb rubber being 3.5-5.5 ounces of rubber.

11. The method of claim 6, further comprising a weight of said resin being between 55 and 75 ounces.

12. The method of claim 6, further comprising said resin being epoxy resin.
